(19) United States
(12) Patent Application Publication
(10) Pub. No.: US 2003/0020734 A1
(43) Pub. Date: Jan. 30, 2003

(54) Method and apparatus for displaying information elements

(76) Inventors: Memphis Zhihong Yin, Corvallis, OR (US); James R. Cole, Albany, OR (US)

Correspondence Address: HEWLETT-PACKARD COMPANY, Intellectual Property Administration, P.O. Box 272400, Fort collins, CO, 80527-2400, US

(21) Appl. No.: 10/179,437

(22) Filed: Jun. 25, 2002

Related U.S. Application Data
(63) Continuation of application No. 09/912,749, filed on Jul. 24, 2001.

(51) Int. Cl. G09G 5/00

(52) U.S. Cl. 345/660

(57) ABSTRACT

A method and apparatus for displaying an information element on a display is disclosed. The method comprises positioning a pointer at the information element displayed on the display, wherein the information element is displayed at a first size. The method continues with creating a focus region on the display, wherein the focus region is nearby the pointer. The method also includes increasing the size of said information element within said focus region.

### CROSS REFERENCE TO RELATED APPLICATION

This application is a Continuation in Part of application Ser. No. 09/912,749, filed Jul. 24, 2001.

### BACKGROUND OF THE INVENTION

The invention relates generally to the field of computers and, more particularly, to the display of information on a display of a computer.

Computers, such as portable laptop and desktop computers, as well as handheld computing devices, have gained in popularity at least in part due to their ability to run many types of computer programs. A laptop computer, for example, can run messaging, computer aided design, and word processing programs. Computers continue to gain in popularity as they become capable of running increasingly diverse types of programs, as well as being able to run these programs simultaneously.

Another contributor to the popularity of computers is the availability of a desktop-based graphical user interface. This interface allows information elements, such as icons, characters, and so forth, to be displayed on a computer display as components of an office desktop. This enables a user to run a particular computer program merely by selecting the information element corresponding to the particular computer program displayed on the desktop. The use of an application window, within which the computer program runs, can then be displayed along with a portion of the computer's desktop. This ability to interact with the computer program by way of the application window, while viewing portions of the computer's desktop, further enhances the appeal and ease of use of computers.

As the number of computer programs capable of running on a computer increases, the computer's display can become increasingly crowded with information elements both on the desktop and within the various application windows within which programs may be running. Thus, users often reduce the size of the application windows as well as the size of the information elements in the desktop area of the display in an attempt to fit all of the information elements on the computer display. However, as the size of the information elements is reduced, the difficulty in reading these elements increases.

### BRIEF DESCRIPTION OF THE DRAWINGS

FIG. 1 shows a portable computer displaying information elements in accordance with a preferred embodiment of the invention;

FIG. 2 shows the computer display desktop of FIG. 1 in greater detail in accordance with a preferred embodiment of the invention;

FIG. 3 shows the computer display desktop of FIG. 1 displaying information elements in accordance with a preferred embodiment of the invention;

FIG. 4 shows a display of a list of operator selections that control attributes of the focus region of FIG. 3 in accordance with a preferred embodiment of the invention;

FIG. 5 is a block diagram showing relevant portions of a system for displaying information elements in accordance with a preferred embodiment of the invention; and

FIG. 6 is a flowchart of a first method for performing selective display area magnification in accordance with a preferred embodiment of the invention.

### DESCRIPTION OF THE PREFERRED EMBODIMENTS

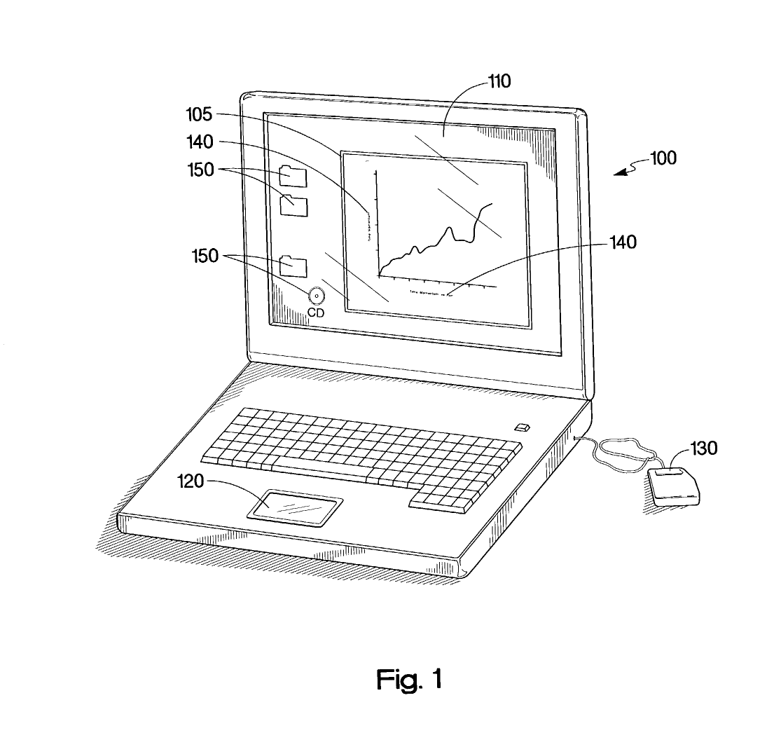

FIG. 1 shows a computer 100 displaying information elements in accordance with a preferred embodiment of the invention. In FIG. 1, application window 105 displays a graph having horizontal and vertical axes. Information elements 140 are labels that identify the data presented in each of the horizontal and vertical axes of the graph presented within application window 105. In addition to displaying application window 105, display 110 also presents information elements 150. Information elements 150 represent computer files that are accessible to a user by way a graphical input device that moves a pointer around the desktop area displayed on display 110. In FIG. 1, one or both of touchpad 120 and mouse 130 may perform the graphical input function, although computer 100 may make use of other input devices, such as a trackpad, touch screen, or keyboard, to generate and convey inputs to computer 100.

In FIG. 1, information elements 140 present information in the form of alphanumeric characters. However, in alternate embodiments of the invention, other types of information elements can be used to present information other than alphanumeric characters. Thus, embodiments of the invention may be used with information elements that are symbols representing portions of an article of manufacture, including electrical circuit elements used in computer programs for the design of electrical equipment, or contour lines used in computer programs for the design of 3-dimensional mechanical structures. Additionally, information elements can include icons that represent individual computer programs and files, symbols, or any other information that may be meaningful to the user of computer 100. FIG. 1 also includes information elements 150, which represent computer file directories that hold various types of computer files. Information elements 150 can also represent one of a variety of programs such as a compact disc (CD) player that runs on computer 100, as well as spreadsheet, word processing, graphics, computer aided design programs, and so forth.

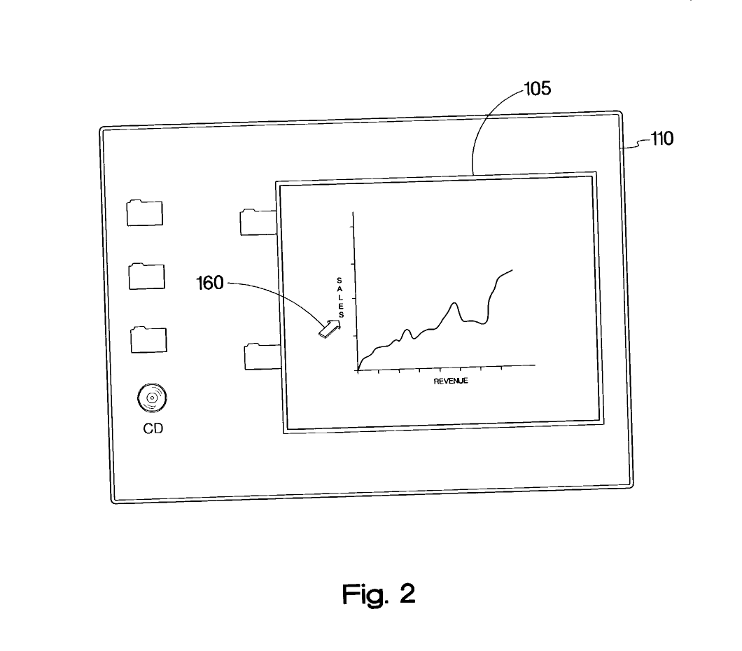

FIG. 2 shows the computer display desktop of FIG. 1 in greater detail in accordance with a preferred embodiment of the invention. In FIG. 2, pointer 160 is positioned at a location just beneath the word “SALES”, which describes the data presented on the vertical axis of the graph shown within application window 105. Preferably, pointer 160 can be positioned at various locations within the bounds of display 110 under the control of a user of computer 100. Although shown as an arrow in FIG. 2, pointer 160 can also be an “I-Beam” pointer that positions a cursor among characters arranged in a program that performs functions such as word processing, spread sheets, or Internet browsing. Pointer 160 can also represent other types of indicators beyond the arrow and I-beam.

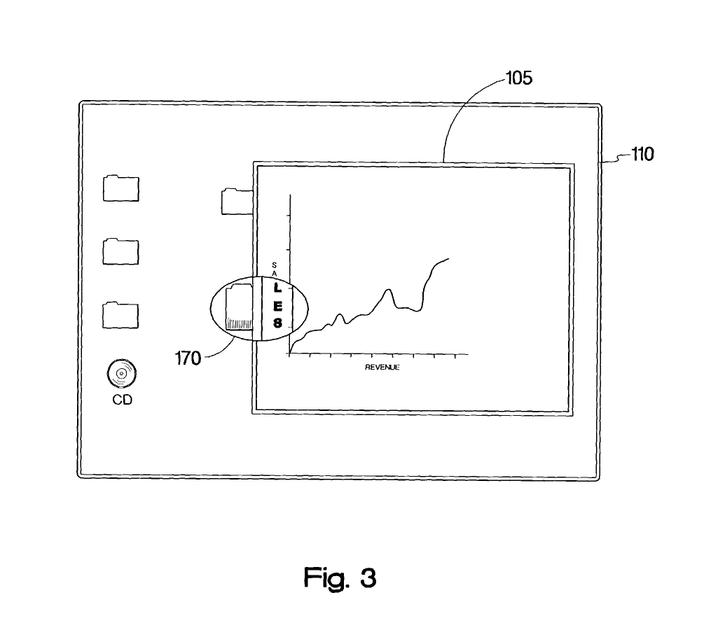

FIG. 3 shows the computer display desktop of FIG. 1 displaying information elements in accordance with a preferred embodiment of the invention. In FIG. 3, pointer 160 (of FIG. 2) has been removed, and focus region 170 is displayed at a location that surrounds the location previously occupied by pointer 160. In an alternate embodiment, pointer 160 may continue to be displayed within or nearby the area occupied by focus region 170. Focus region 170 can be located nearby the location previously occupied by pointer 160, such as above, to the side of, or below the location. Additionally, focus region 170 can initially appear at a predetermined spot on display 110, such as in the center or near a boundary of display 110.

Focus region 170 represents an area that can be moved within the bounds of display 110 under the control of a graphical input device, such as mouse 130 or touchpad 120. Within focus region 170, any of information elements 140 and 150 is magnified relative to the information elements located outside of focus region 170.

In FIG. 3, area 170 is shown as magnifying a region that includes a portion of the vertical axis of the graph within application window 105, a portion of the identifier of the vertical axis (“SALES”), an edge of application window 105, and a portion of one of information elements 150 located on the desktop of display 110.

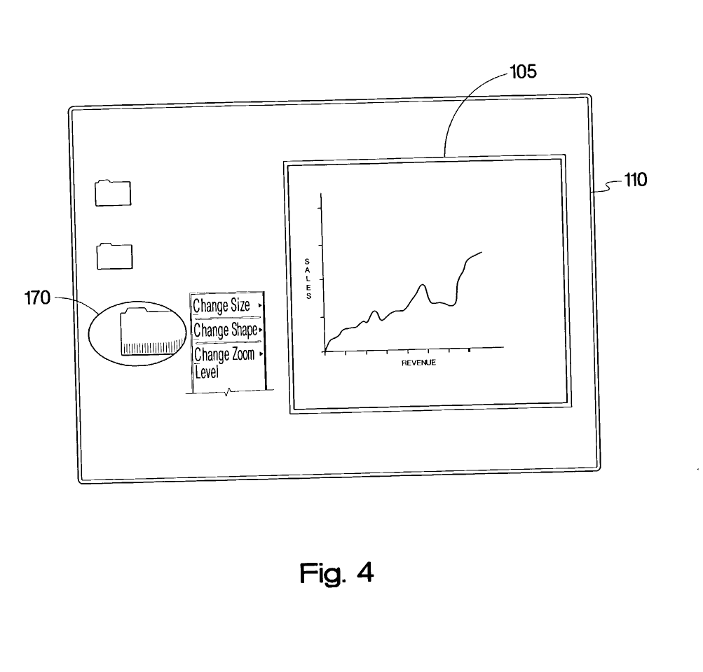

FIG. 4 shows a display of a list of operator selections that control attributes of the focus region of FIG. 3 in accordance with a preferred embodiment of the invention. These attributes are controlled by way of an input device, such as one or more buttons located on mouse 130, or adjacent to touchpad 120 (shown in FIG. 1). Preferably, the input device allows the user to change the size of focus region 170, to change the shape of focus region 170, to change the magnification level (“zoom”) of focus region 170, or to bring about another change in a characteristic of the information elements that lie within focus region 170. Alternatively, these changes may be brought about by way of depressing a key on the keyboard of an associated computing device, such as a function key (for example, F1 through F12 keys on many standard keyboards) or by depressing a key that has been adapted or configured for use with controlling attributes of focus region 170.

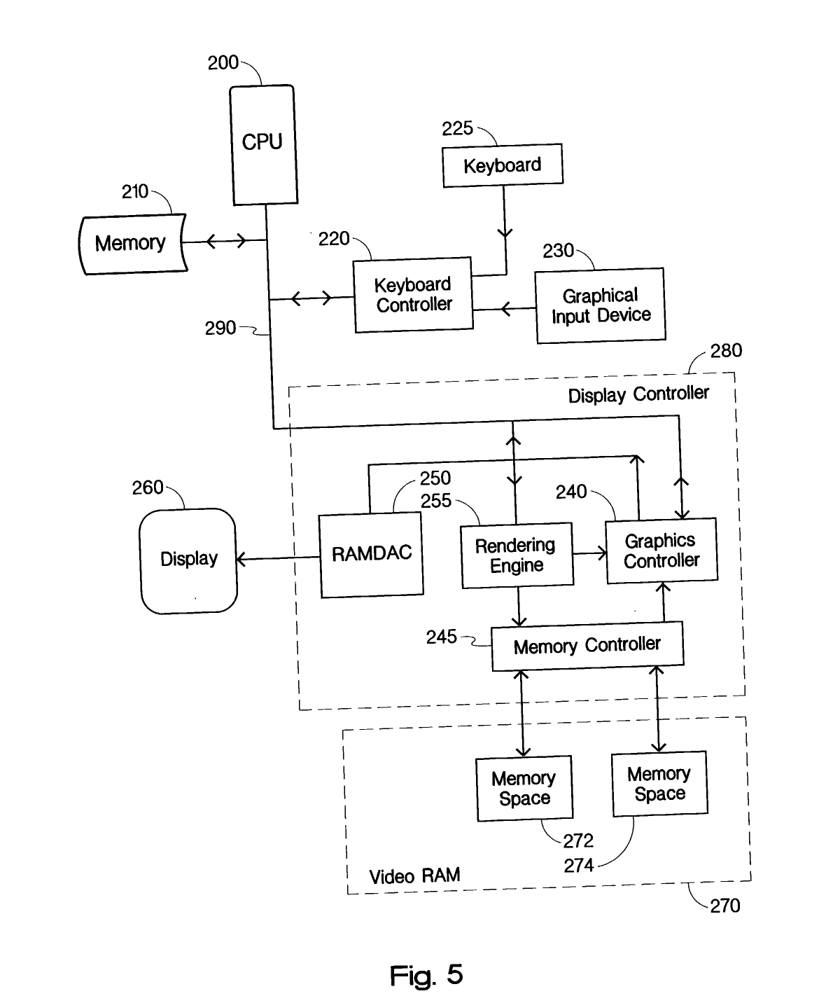

FIG. 5 is a block diagram showing relevant portions of a system for displaying information elements in accordance with a preferred embodiment of the invention. In FIG. 5, an operating system that runs on central processing unit (CPU) 200 controls and directs the operations of memory 210 as well as other processing resources of the system. Memory 210 represents one of several types of memory including volatile and nonvolatile memory. The operating system that runs on CPU 200 further directs the operations of keyboard controller 220, display controller 280, as well as other processing resources not shown in FIG. 5, by way of bus 290.

The user of the computer of FIG. 5 generates and moves information elements on display 260 by way of a process that begins by interacting with one or more of keyboard 225 and input device 230. Commands from keyboard 225 and input device 230 are interpreted by keyboard controller 220, which processes inputs from these devices and transmits commands to move information elements within the bounds of display 260.

Display 260 can be any type of computer display capable of displaying one or more types of information elements, such as information elements 140 and 150 (of FIG. 1), as well as application windows, such as application window 105. Display 260 can incorporate flat panel technology, such as liquid crystal, light emitting diodes, cathode ray tubes, or other display technology. Desirably, display 260 performs at least some functions similar to those performed by display 110 (of FIG. 1).

In FIG. 5, commands from keyboard controller 220 are conveyed along bus 290 to display controller 280. Rendering engine 255 within display controller 280 depicts the area within the bounds of display 260 by writing renderings of information elements, background between adjacent information elements, and application windows, in memory space 272 within video random access memory (VRAM) 270. Memory space 272 is preferably a two-dimensional memory array that corresponds to the area within the bounds of display 260. Once the rendering of the area within the bounds of display 260 is stored within memory space 272, graphics controller 240 periodically or occasionally reads the contents of memory space 272, in a sequential manner and converts these contents into digital representations of information elements and background. These digital representations are then sequentially written to random access memory digital to analog converter (RAMDAC) 250. RAMDAC 250 then converts the digital representations to an analog format for display on display 260. Memory controller 245 manages and coordinates access to VRAM 270 by graphics controller 240 and rendering engine 255 so that data can be written to and read from VRAM 270 without adversely affecting the contents of VRAM 270.

In the embodiment of FIG. 5, graphics controller 240 makes use of a scale factor so that the contents of memory space 272 can be displayed in a manner that occupies the area within the bounds of display 260. The scale factor is assigned to the contents of memory space 272 by graphics controller 240. The scale factor enables similar information elements to be presented on display 260 using a consistent number of pixels.

In a preferred embodiment, memory space 272 is periodically or occasionally updated to reflect inputs from keyboard 225 and graphical input device 230 as conveyed through keyboard controller 220 and bus 290. These inputs include commands from a user to generate and move information elements within the bounds of display 260.

Rendering engine 255 preferably keeps track of the current location of the pointer located on display 260 by way of receiving commands to update the location of the pointer as received from keyboard controller 220. When the user desires to create a focus region, the user interacts with either or both of keyboard 225 and input device 230 so that a focus region can be established in addition to or in place of the pointer. In response to a command to create a focus region, rendering engine 255 renders a focus region using memory space 274, located outside of memory space 272. Rendering engine 255 then informs graphics controller 240 that the contents of memory space 274 are to be assigned a scale factor that is different than the scale factor assigned to the contents of memory space 272. Thus, graphics controller 240 can sequentially read memory spaces 272 and 274, assigning different scale factors to the contents read from each memory space, and convey the digital representations that represent the focus region as well as the remainder of the area within the bounds of display 260 to RAMDAC 250. RAMDAC 250 then converts the digital representations to an analog format for display on display 260.

As an alternative to rendering engine 255 providing graphics controller 240 with a first scale factor being assigned to memory space 272 and a second scale factor being assigned to the contents of memory space 274, the size of information elements within a focus region can also be increased by allowing the information elements to consume a larger number of memory locations within memory space 274 than in memory space 272. For example, if it is desired that a focus region present information elements as being twice as large as a similar elements located outside the focus region, the information element within memory space 274 can be allowed to consume twice as many memory locations as the information element consumes when the element is stored in memory space 272. This, in turn, causes the information elements rendered in memory space 274 to be displayed using twice as many pixels on display 260.

As the user moves the focus region within the bounds of display 260, rendering engine 255 receives updates from keyboard controller 220. These updates, in turn, are used to update the contents of memory space 274. Rendering engine 255 also informs graphics controller 240 of the new location of the focus region within display 260 so that graphics controller 240 can update the location of the focus region within RAMDAC 250 for display on display 260.

As the user selects to change the magnification level of the focus region, CPU 200, under the control of an operating system, receives the user selection by way of keyboard controller 220 and changes the scale factor applied to the focus region by graphics controller 240. Alternatively, the magnification level of the focus region can be changed by storing information elements within an area of memory that corresponds to a larger or smaller number of pixels on display 260. Additionally, if the user wishes to change the size, shape, or other attribute of the focus region, CPU 200 can convey the change to rendering engine 255 so that the change can be reflected in memory space 272.

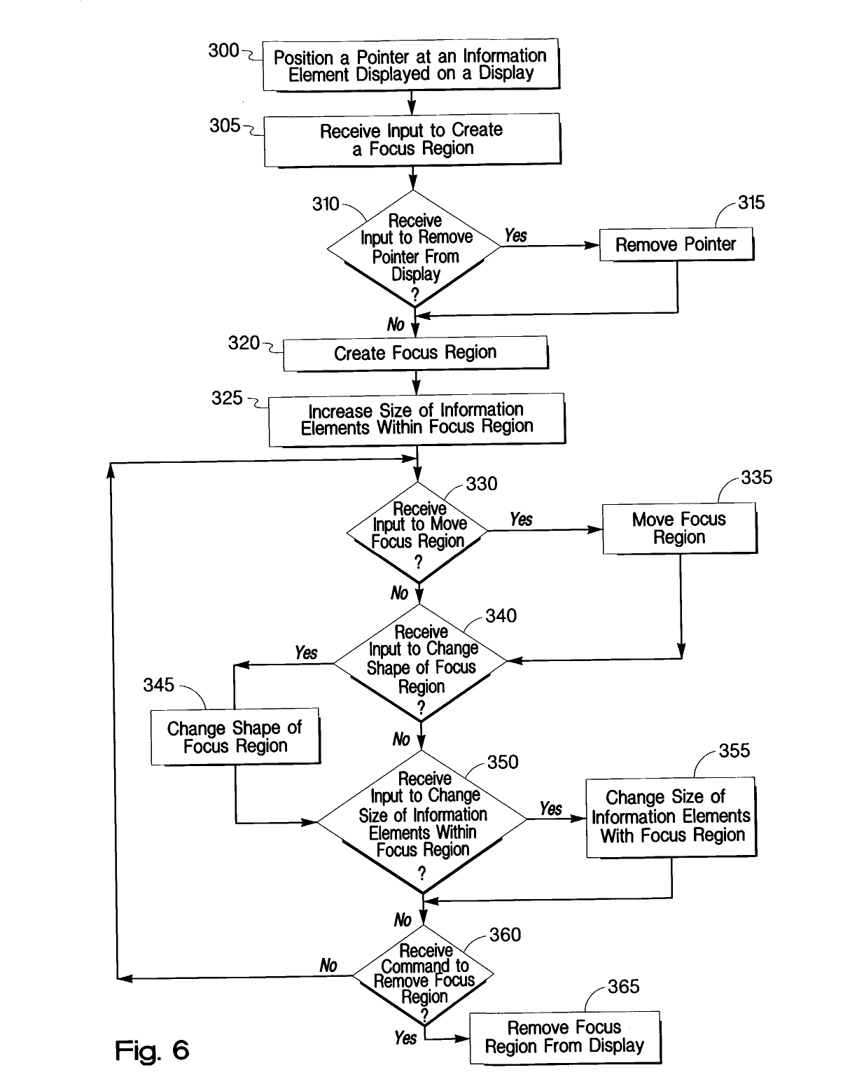

FIG. 6 is a flowchart of a method for displaying information elements in accordance with a preferred embodiment of the invention. The method of FIG. 6 can be performed using one or more computer-readable media having computer-readable instructions thereon which, when executed by a computer, cause the computer to perform the method. The method begins at step 300 in which a pointer is positioned at an information element displayed on a display. The pointer identified in step 300 can be positioned by way of a user interacting with a graphical input device, such as a mouse, touchpad, and so forth, or through the use of a keyboard. The method continues at optional step 305 in which an input to create a focus region is received. In some embodiments, step 305 is not present since a focus region can be created as an automatic feature of a computer program that does not require a user input.

The method of FIG. 6 continues at step 310 in which a decision is made as to whether an input has been received to remove the pointer from the display. If an input to remove the pointer has been received, the method continues at step 315 in which the pointer is removed from the display, and the method continues at step 320 in which a focus region is created at a location nearby the location previously occupied by the pointer. The location at which the focus region is created may surround the location previously occupied by the pointer, or may be located above, below, or to one side of the location previously occupied by the pointer.

If the decision of step 310 indicates that an input to remove the pointer has not been received, a focus region is created, at step 320, without removing the pointer from the display. In the event that the pointer is not removed, the location at which the focus region is created may surround the pointer, or may be located above, below, or to one side of the pointer.

The method continues at step 325 in which information elements within the focus region are increased in size. At step 330, a decision is made as to whether an input to move the focus region has been received. If an input to move the focus region has been received, step 335 is executed in which the focus region is moved to a new location within the bounds of the display and the method continues at step 340. If the decision of step 330 indicates that an input to move the focus region has not been received, step 340 is executed without moving the focus region.

At step 340, a decision is made as to whether an input to change the shape of the focus region has been received. If an input to change the shape of the focus region has been received, step 345 is executed in which the shape of the focus region is changed and the method continues at step 350. Step 345 can be performed by way of modifying the memory locations that correspond to the focus region. For example, in the embodiment of FIG. 5, the memory space 274 can be changed to correspond to the desired new shape of the focus region. In an alternate embodiment, memory space 274 remains unchanged while graphics controller (such as graphics controller 240 of FIG. 5) is instructed to read the portion of memory space 274 that corresponds to new shape of the focus region.

If the decision of step 340 indicates that an input to change the shape of the focus region has not been received, step 350 is executed without changing the shape of the focus region. At step 350, a decision is made as to whether an input to change the size of information elements within the focus region has been received. If an input to change the size of the information elements within the focus region has been received, block 355 is executed in which the size of the information elements within the focus region is changed, and the method continues at step 360. If the decision of step 350 indicates that an input to change the size of the information elements within the focus region has not been received, the method continues at step 360 without changing the size of the information elements within the focus region. In step 360, a decision is made as to whether an input to remove the focus region is received. If the input has been received, step 365 is executed and the focus region is removed. If the input has not been received, the method returns to step 330.

While the flowchart of FIG. 6 can represent a procedure having a particular order, nothing prevents the execution of the method in any other order. Additionally, one or more of decision steps 310, 330, 340, 350, and 360, as well as steps 315, 335, 345, 355, and 365, which result from these decision steps, may be eliminated from the method in various embodiments. Thus, an embodiment of the invention can be implemented in a flowchart that merely includes steps 300 (positioning a pointer at an information element displayed on a display), step 320 (creating a focus region), and step 325 (increasing the size of information elements within the focus region).

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method for displaying an information element on a display, comprising:
positioning a pointer at said information element displayed on said display, said information element being displayed at a first size;
creating a focus region on said display, said focus region positioned nearby said pointer; and
increasing the size of said information element within said focus region.

2. The computing system of claim 1, additionally comprising receiving an input to create said focus region, said receiving step being prior to said creating step.

3. The method of claim 1, wherein said focus region surrounds said pointer on said display.

4. The method of claim 1, wherein said focus region is positioned at a location is selected from the group consisting of above, below, and to the side of said pointer.

5. The method of claim 1, further comprising removing said pointer from said display.

6. The method of claim 5, wherein said focus region is created in a location surrounding the location formerly occupied by said pointer.

7. The method of claim 5, wherein said focus region is created in a location selected from the group consisting of above, below, and to the side of the location formerly occupied by said pointer.

8. The method of claim 1, further comprising moving said focus region to a second location within the bounds of said display.

9. The method of claim 8, further comprising receiving a command to move said focus region to said second location.

10. The method of claim 1, further comprising changing said information elements within said focus region from said increased size to a size different than said increased size.

11. The method of claim 1, further comprising changing the size of said focus region.

12. The method of claim 11, further comprising receiving a command to change the size of said focus region.

13. The method of claim 1, further comprising changing the shape of said focus region.

14. The method of claim 13, further comprising receiving a command to change the shape of said focus region.

15. A computer that modifies the size of information elements displayed on a display, comprising:
a display that displays information elements using a first element size;
a graphics controller coupled to said display that assigns a first scale factor to a first memory space corresponding to a focus region of said display and assigns a second scale factor to a second memory space corresponding to an area outside of said focus region of said display,
wherein said first scale factor causes an information element to be displayed at a first size, and wherein said second scale factor causes said information element to be displayed at a size greater than said first size.

16. The computer of claim 15, additionally comprising a keyboard controller, coupled to said graphics controller, for controlling the position of said focus region on said display in response to an input from a user.

17. The computer of claim 15, additionally comprising a central processing unit for changing a scale factor applied to said focus region, said changing of said scale factor being in response to a user input.

18. The computer of claim 15, wherein said information elements are portions of an office desktop simulated by a computer program that runs on said computing system.

19. The computer of claim 15, wherein said information elements represent characters used in a word processing program.

20. The computer of claim 15, wherein said information elements represent portions of one of the group consisting of an electrical circuit and a mechanical apparatus.

21. One or more computer-readable media having computer-readable instructions thereon which, when executed by a computer, cause the computer to perform a method comprising:
positioning, in response to a first user input, a pointer on a display, said display displaying information elements;
creating a focus region in response to a second user input; and
displaying said focus region on said display, wherein information elements within said focus region are displayed at a greater size than information elements outside said focus region.

22. The computer-readable media of claim 21, wherein said method further comprises removing said pointer from said display.

23. The computer-readable media of claim 21, wherein said focus region surrounds the location of said pointer prior to said removing action.

24. The computer-readable media of claim 21, wherein said information elements are alphanumeric characters.

25. The computer-readable media of claim 21, wherein said information elements represent computer programs.

26. The computer-readable media of claim 21, wherein said method further comprises receiving an input that moves said focus region to a second location.

27. The computer-readable media of claim 26, wherein said input is received from a graphical input device.

28. A computer that modifies the size of information elements displayed on a display, comprising:
means for displaying information elements using a first element size;
means for positioning a pointer on said means for displaying; and
means for changing the size used to display information elements proximate to said pointer to a second element size that is greater than said first element size, said means for changing being coupled to said means for displaying and said means for positioning.
